(19) United States
(12) Patent Application Publication
(10) Pub. No.: US 2024/0066502 A1
(43) Pub. Date: Feb. 29, 2024

(54) CHLORINE GAS DECOMPOSITION CATALYST, EXHAUST GAS TREATMENT DEVICE, AND METHOD FOR DECOMPOSING CHLORINE GAS

(71) Applicant: Resonac Corporqtion, Tokyo (JP)

(72) Inventors: Kunchan LEE, Minato-ku, Tokyo (JP); Kazuki IWAGAKI, Minato-ku, Tokyo (JP); Toshinori MORIYA, Minato-ku, Tokyo (JP); Hitoshi ATOBE, Minato-ku, Tokyo (JP)

(73) Assignee: Resonac Corporation, Tokyo (JP)

(21) Appl. No.: 18/269,373

(22) PCT Filed: Dec. 23, 2021
(86) PCT No.: PCT/JP2021/047971

§ 371 Date: Oct. 6, 2023

(30) Foreign Application Priority Data
Dec. 25, 2020 (JP) 2020-217753

(51) Int. Cl. B01J 23/10; B01D 53/86; B01J 23/75

(52) U.S. Cl. CPC B01J 23/10; B01D 53/8662; B01J 23/75; B01D 2257/2025; B01D 2257/2066

(57) ABSTRACT

To provide a means removing chlorine gas, which can remove chlorine gas contained in, for example, exhaust gas with high efficiency and does not require frequent exchange. A chlorine gas decomposition catalyst including a metal oxide (X), wherein the metal oxide (X) includes an oxide (X1) of at least one element selected from the group consisting of Ce and Co.

### TECHNICAL FIELD

The present invention relates to a chlorine gas decomposition catalyst, an exhaust gas treatment apparatus using the catalyst, and a method for decomposing chlorine gas.

### BACKGROUND ART

Chlorine gas may be contained in gases exhausted from, for example, manufacturing courses of compounds and various industrial processes. Chlorine gas is toxic and required to be removed, and therefore various methods have been conventionally employed to remove it.

For example, Patent Literatures 1 and 2 disclose a method for removing chlorine gas by bringing exhaust gas containing chlorine gas into contact with an alkaline solution. Moreover, Patent Literatures 3 and 4 disclose a method for removing chlorine gas by adsorbing halogen-based gases such as chlorine gas onto an adsorbent (an agent for rendering the gas harmless) containing a zeolite.

### CITATION LIST

### Patent Literature

[Patent Literature 1] JP2005-305414A
[Patent Literature 2] JP2008-110339A
[Patent Literature 3] JP2008-229610A
[Patent Literature 4] JP2016-155072A

### SUMMARY OF INVENTION

### Technical Problem

However, conventional methods for removing chlorine gas have had room for further improvement in terms of efficiency of removing chlorine gas. Moreover, the method for removing chlorine gas using an adsorbent has caused inconvenience in that the adsorbent has to be exchanged frequently.

Thus, an object of the present invention is to provide, for example, a means removing chlorine gas and a method for removing chlorine gas, which can remove chlorine gas contained in for example, exhaust gas with high efficiency and do not require frequent exchange.

### Solution to Problem

The present invention relates to, for example, the following [1] to [16].

[1]

A chlorine gas decomposition catalyst comprising a metal oxide (X), wherein

the metal oxide (X) comprises an oxide (X1) of at least one element selected from the group consisting of Ce and Co.

[2]

The chlorine gas decomposition catalyst according to [1], wherein the oxide (X1) comprises cerium oxide.

[3]

The chlorine gas decomposition catalyst according to [1] or [2], wherein the oxide (X1) comprises a composite oxide of Ce and at least one element M selected from the group consisting of Mg, Cr, Mn, Fe, Co, Ni, Cu and Zr.

[4]

The chlorine gas decomposition catalyst according to [3], wherein the metal oxide (X) further comprises an oxide of the element M excluding Co.

[5]

The chlorine gas decomposition catalyst according to any one of [1] to [4], wherein the oxide (X1) comprises cobalt oxide.

[6]

The chlorine gas decomposition catalyst according to any one of [1] to [5], comprising a support and the metal oxide (X) supported on the support.

[7]

The chlorine gas decomposition catalyst according to any one of [1] to [6] for decomposing chlorine gas contained in exhaust gas.

[8]

An exhaust gas treatment apparatus comprising a reactor into which exhaust gas containing chlorine gas is introduced, wherein the reactor is provided with the chlorine gas decomposition catalyst according to any one of [1] to [7].

[9]

The exhaust gas treatment apparatus according to [8], wherein the exhaust gas contains a perfluoro compound.

[10]

The exhaust gas treatment apparatus according to [9], wherein the reactor is provided with a perfluoro compound decomposition catalyst.

[11]

The exhaust gas treatment apparatus according to any one of [8] to [10], comprising a device that supplies water to the exhaust gas.

[12]

The exhaust gas treatment apparatus according to any one of [8] to [11], comprising a heating device that heats the exhaust gas.

[13]

The exhaust gas treatment apparatus according to any one of [8] to [12], comprising a cooling device that cools gas exhausted from the reactor.

[14]

The exhaust gas treatment apparatus according to any one of [8] to [13], comprising a removal device that removes an acid gas from gas exhausted from the reactor.

[15]

The exhaust gas treatment apparatus according to any one of [8] to [14], comprising a temperature detector that detects a temperature of the exhaust gas supplied to the reactor, and a controller that controls the heating device based on temperature measured by the temperature detector.

[16]

A method for decomposing chlorine gas, comprising bringing a gas containing chlorine gas into contact with the chlorine gas decomposition catalyst according to any one of [1] to [7] in the presence of water.

### Advantageous Effects of Invention

By using of the chlorine gas decomposition catalyst of the present invention, chlorine gas contained in, for example, exhaust gas, can be removed with high efficiency. The chlorine gas decomposition catalyst of the present invention can also be used without its frequent exchange.

### BRIEF DESCRIPTION OF DRAWING

FIG. 1 is an XRD pattern of the chlorine gas decomposition catalyst produced in Example 1.

FIG. 2 is an XRD pattern of the chlorine gas decomposition catalyst produced in Example 2.

FIG. 3 is an XRD pattern of the chlorine gas decomposition catalyst produced in Example 3.

FIG. 4 is an XRD pattern of the chlorine gas decomposition catalyst produced in Example 4.

FIG. 5 is an XRD pattern of the chlorine gas decomposition catalyst produced in Example 5.

FIG. 6 is an XRD pattern of the chlorine gas decomposition catalyst produced in Example 6.

FIG. 7 is an XRD pattern of the chlorine gas decomposition catalyst produced in Example 7.

FIG. 8 is an XRD pattern of the chlorine gas decomposition catalyst produced in Example 8.

FIG. 9 is an XRD pattern of the chlorine gas decomposition catalyst produced in Example 9.

FIG. 10 is an XRD pattern of the chlorine gas decomposition catalyst produced in Example 10.

FIG. 11 is an XRD pattern of the chlorine gas decomposition catalyst produced in Example 11.

FIG. 12 is an XRD pattern of the chlorine gas decomposition catalyst produced in Example 12.

FIG. 13 is an XRD pattern of the chlorine gas decomposition catalyst produced in Example 13.

FIG. 14 is an XRD pattern of the chlorine gas decomposition catalyst produced in Example 14.

FIG. 15 is an XRD pattern of the chlorine gas decomposition catalyst produced in Example 15.

FIG. 16 is an XRD pattern of the chlorine gas decomposition catalyst produced in Comparative Example 1.

FIG. 17 is an XRD pattern of the chlorine gas decomposition catalyst produced in Comparative Example 2.

FIG. 18 is a configuration view of an aspect of the exhaust gas treatment apparatus of the present invention.

### DESCRIPTION OF EMBODIMENT

The present invention will be described in more detail below.

[Chlorine Gas Decomposition Catalyst]

The chlorine gas decomposition catalyst according to the present invention is a chlorine gas decomposition catalyst including a metal oxide (X), wherein the metal oxide (X) includes an oxide (X1) of at least one element selected from the group consisting of Ce (cerium) and Co (cobalt), i.e., an oxide (X1) of Ce (cerium) and/or Co (cobalt).

(Metal oxide (X))

The metal oxide (X) includes an oxide (X1) of at least one element selected from the group consisting of Ce and Co.

The oxide (X1) preferably includes,
(1) at least one cerium-based oxide selected from the group consisting of cerium oxide and composite oxides of Ce and at least one element M selected from the group consisting of Mg, Cr, Mn, Fe, Co, Ni, Cu and Zr,
(2) cobalt oxide, or
(3) both the cerium-based oxide (1) and the cobalt oxide (2).

When the oxide (X1) includes the composite oxide excluding a composite oxide including Co, the metal oxide (X) may further contain an oxide (X2) of the element M excluding Co.

The cerium oxide preferably includes CeO₂.

The metal element M is preferably at least one selected from the group consisting of Cr, Mn, Fe, Co, Ni and Cu and more preferably Cr, Co and Cu.

When the oxide (X1) includes a composite oxide of Ce and the metal element M, a proportion of atoms of the metal element M in the metal oxide (X) may preferably be 0.001 to 2.0 moles and more preferably 0.1 to 1.8 moles, relative to 1 mole of Ce atoms. The proportion of atoms of metal element M that is the aforementioned upper limit value or less allows the metal oxide (X) to be highly active in decomposing chlorine gas, thereby making it possible for the chlorine gas decomposition catalyst according to the present invention to remove chlorine gas contained in, for example, exhaust gas with high efficiency.

The cobalt oxide (2) preferably includes CO₃O₄.

A proportion of the cobalt oxide (2) in the aspect of (3) above may be a proportion such that cobalt atoms in the cobalt oxide (2) are preferably 2.0 moles or less, more preferably 0.1 to 2.0 moles and more preferably 1.0 to 1.8 moles, relative to 1 mole of cerium atoms in the cerium-based oxide (1).

(Support)

The chlorine gas decomposition catalyst according to the present invention may further contain a support, i.e., it may be a chlorine gas decomposition catalyst including a support and the metal oxide (X) supported on the support (hereinafter also referred to as “supported type catalyst”). The chlorine gas decomposition catalyst that is a supported type catalyst generally has a larger specific surface area, and is therefore preferred from the viewpoint of improving catalytic activity.

A shape and size of the aforementioned support are not particularly limited, but the support preferably has a structure in the form of, for example, a bead, pellet, powder, or granules, or a monolithic structure, and particularly preferably has a structure in the form of pellet.

The support is preferably composed of a porous material, and has a specific surface area as measured by BET method of, for example, 100 to 500 cm²/g and preferably 100 to 300 cm²/g.

A constituent of the support is preferably a component inert or less reactive to chlorine gas and hydrogen chloride produced by a decomposition reaction of the chlorine gas and includes, for example, alumina (Al₂O₃), silica (SiO₂), cordierite, or a zeolite and preferably alumina.

An average particle size (diameter) of the supports is, for example, 1 to 10 mm and preferably 2 to 5 mm.

(Method for producing chlorine gas decomposition catalyst)

Among the methods for producing a chlorine gas decomposition catalyst according to the present invention, examples of the methods in which a support is not contained, include
a method for producing a chlorine gas decomposition catalyst including a step of pulverizing and mixing powders of the metal oxides (X) (for example, cerium oxide powder and cobalt oxide powder)
and optionally a step of calcining the powder that was pulverized and mixed at 500 to 900° C. in air.

Conventional known methods, such as use of a ball mill, can be applied for pulverizing and mixing powder of the metal oxide (X).

Examples of methods for producing the supported type catalyst among the chlorine gas decomposition catalysts according to the present invention, include
a method for producing a chlorine gas decomposition catalyst including a step (1) of preparing a support product allowing a raw material component of the metal oxide (X) to be impregnated in the support (i.e., a support in which the raw material component or a component containing a metal in the raw material component is supported on the support), and
a step (2) of calcining the support product to obtain a chlorine gas decomposition catalyst.

<Step (1)>

Examples of raw material components of the metal oxides (X) include respective salts of Ce, Co, and other metal elements. The salts may be hydrates.

Examples of the salts include nitrates, chlorides, bromides, sulfates, and carbonates, of which nitrates and chlorides are preferred, and nitrates are further preferred.

Specific examples of nitrates include cerium(III) nitrate hexahydrate, cobalt(II) nitrate hexahydrate, nickel(II) nitrate hexahydrate, chromium(III) nitrate nonahydrate, iron(III) nitrate nonahydrate, manganese(II) nitrate hexahydrate, magnesium nitrate hexahydrate, zirconium nitrate dihydrate, and copper(II) nitrate trihydrate.

The raw material component of the metal oxide (X) may be the metal oxide (X) itself or some oxide in the metal oxide (X). Examples of such oxides include cobalt oxide (Co₃O₄). Moreover, an average particle size of the oxides as the raw material components, for example, a value of D50 measured by the method employed in Examples, is preferably 0.1 to 10 μm.

The aforementioned step (1) is carried out, for example,
by a method (a) including a step (11a) of dissolving the raw material components in water to prepare an impregnating solution; and
a step (12a) of bringing the impregnating solution and the support into contact with each other, and then recovering the obtained support product;
a method (b) including a step (11b) of dispersing the raw material components in water to prepare an impregnating solution; and
a step (12b) of bringing the impregnating solution and the support into contact with each other, and then recovering the obtained support product; or
a method (c) including a step (11a) of dissolving the raw material components in water to prepare an impregnating solution;
a step (11b) of dispersing the raw material components in water to prepare an impregnating solution; and
a step (12c) of bringing the two impregnating liquids and the support into contact with each other, and then recovering the obtained support product.

When only the salt is used as the raw material component, the method (a) is preferably carried out.

When only the oxide is used as the raw material component, the method (b) is preferably carried out.

When the salt and the oxide are used as the raw material components, the method (c) is preferably carried out.

Examples of aspects of step (12c) include
an aspect of mixing the two impregnating liquids, bringing the obtained mixture and the support into contact with each other, and then recovering the obtained support product; and
an aspect of bringing one of the impregnating liquids and the support into contact with each other, then recovering the obtained support product, bringing this support product and the other impregnating liquid into contact with each other, and then recovering the obtained support product.

Examples of the method for bringing the impregnating liquid and the support into contact with each other to support the raw material components on the support include conventionally known methods, such as impregnation methods (for example, a heat impregnation method, ordinary temperature impregnation method, vacuum impregnation method, ordinary pressure impregnation method, impregnation drying method, pore filling method), immersion method, wet adsorption method, spray method, coating method, and combinations thereof.

Among these methods, the pore filling method is referred from the viewpoints of supporting the raw material components with its high dispersibility on the support, improvement in catalytic activity and facilitation of industrial implementation.

Bringing the impregnating liquid and the support into contact with each other allows the raw material components to be stably supported with its high dispersibility on the surface of the support and further in pores thereof when the support is composed of a porous material.

A contact between the impregnating liquid and the support may be carried out under atmospheric pressure or reduced pressure.

The contact between the impregnation liquid and the support may be carried out in the vicinity of room temperature (for example, 5 to 40° C.), or at higher temperatures by heating (for example, 40 to 85° C.).

The recovered support product is preferably dried. The drying can be carried out by a conventionally known means such as air drying and heating.

The drying is carried out, for example, under the following conditions.

Temperature: Temperature at which supported material components do not decompose (for example, room temperature to 300° C.).

Time: 0.5 to 50 hours.

Pressure: At ordinary or reduced pressure.

Atmosphere: Air, inert gases (for example, an argon gas, nitrogen gas, and helium gas), an oxygen gas, or a mixture of these gases.

<Step (2)>

In step (2), the support product obtained in step (1) is calcined to obtain a chlorine gas decomposition catalyst.

The calcination is carried out, for example, under the following conditions.

Temperature: 300 to 1200° C. and preferably 400 to 800° C.

Time: 0.5 to 10 hours and preferably 1 to 3 hours.

Pressure: Ordinary pressure, reduced pressure or pressurized pressure.

Atmosphere: Air, inert gases (for example, argon gas, nitrogen gas, and helium gas), an oxygen gas, or a mixture of these gases.

In the catalyst obtained by this calcination, metal components in forms of oxides or composite oxides are supported on a support while they are highly dispersed therein.

[Exhaust Gas Treatment Apparatus]

The exhaust gas treatment apparatus according to the present invention includes a vessel into which exhaust gas containing chlorine gas is introduced, i.e., a reactor, wherein the reactor is provided with a chlorine gas decomposition catalyst according to the present invention.

The exhaust gas treatment apparatus according to the present invention will be described while referring to the drawings.

FIG. 18 shows a configuration view of an aspect of the exhaust gas treatment apparatus of the present invention. An exhaust gas treatment apparatus 1 of the present aspect includes a first scrubber 3 in which water injection is carried out by a spray 2 for exhaust gas (a perfluoro compound gas (hereinafter also referred to as “PFC gas”) or an acid gas, including a chlorine gas), a reactor 5 in which the exhaust gas that has passed through the first scrubber 3, pure water, and air, are introduced to carry out a decomposition reaction of chlorine gas in the exhaust gas, a cooler 7 cooling the exhaust gas that has passed through the reactor 5, a second scrubber 10 in which water injection is carried out by a spray 9 for the exhaust gas that has passed through the cooler 7, a blower 11 for sending the treated exhaust gas that has passed through the second scrubber 10 out of the system, and a tank 13 for collecting drainage collected from the cooler 7.

An inside of the reactor 5 is filled with a chlorine gas decomposition catalyst 4, and a heater 6 is installed in the circumference of the reactor 5.

The reactor 5 can be appropriately set depending on, for example, a type of exhaust gas and a scale of an exhaust gas treatment apparatus.

Examples of the exhaust gases include those exhausted, for example, in the production course of compounds or from various industrial processes. Specific examples thereof include etching gases used in manufacturing processes of semiconductors or liquid crystals, or cleaning gases used in pieces of CVD device. These exhaust gases may contain a perfluoro compound. Examples of the perfluoro compounds include CF₄, CHF₃, C₂F₆, C₃F₆, C₄F₆, SF₆, and NF₃.

The reactor 5 may be provided with, in addition to the chlorine gas decomposition catalyst 4, a perfluoro compound decomposition catalyst 14 (not shown). The perfluoro compound decomposition catalyst 14 may be a conventionally known catalyst, for example, a nickel oxide catalyst.

Using the chlorine gas decomposition catalyst according to the present invention as the chlorine gas decomposition catalyst 4 enables decomposition of chlorine gas with high efficiency without separating the reactor 5 provided with the chlorine gas decomposition catalyst 4 and the reactor 5 provided with the perfluoro compound decomposition catalyst 14.

The chlorine gas decomposition catalyst 4 and the perfluoro compound decomposition catalyst 14 may each be filled inside the reactor 5, or may be provided as catalyst layers on the inner wall of the reactor 5.

The chlorine gas decomposition catalyst 4 and the perfluoro compound decomposition catalyst 14 may be mixed and filled into the reactor 5, or may be separately filled into the reactor 5.

The exhaust gas treatment apparatus 1 according to the present invention preferably includes a device that supplies water to exhaust gas to be introduced into the reactor 5. With the exhaust gas treatment apparatus 1 including this device, the decomposition reaction of chlorine gas described below can be carried out smoothly even when the exhaust gas does not originally contain water.

The exhaust gas treatment apparatus 1 preferably includes a heating device 6 (for example, a heater) that heats exhaust gas containing chlorine gas to a temperature at which the decomposition reaction of chlorine gas is carried out.

For example, the reactor 5 may be provided with the heating device 6 (for example, a heater installed in the circumference of the reactor) that heats an inside of the reactor 5 to a temperature at which the decomposition reaction of chlorine gas is carried out, or the exhaust gas treatment apparatus 1 may include the heating device 6 (for example, a heater) that heats exhaust gas containing chlorine gas to a temperature at which the decomposition reaction of chlorine gas is carried out before introduction of the exhaust gas containing chlorine gas to the reactor 5.

The exhaust gas treatment apparatus 1 preferably includes a cooling device 8 that cools the gas exhausted from the reactor 5. Examples of this cooling device 8 preferably includes a device (for example, a spray 8 spraying water) that brings cooling water into contact with the gas within the cooler 7. Bringing the cooling water into contact with the gas makes it possible to remove hydrogen chloride, which is a decomposition product of chlorine gas, contained in the gas and further to dissolve hydrogen fluoride that is a decomposition product of the following compound in cooling water and then remove it in a case in which the exhaust gas contains the perfluoro compound.

Cooling water in which, for example, hydrogen chloride is dissolved, is exhausted by a pump 12 into a tank 13.

The exhaust gas treatment apparatus 1 preferably includes a removal device (for example, a second scrubber 10) that removes acid gases (a hydrogen chloride gas and hydrogen fluoride gas) from the gas that has been exhausted from the reactor 5 and passed through the cooling device.

The exhaust gas treatment apparatus preferably includes a temperature detector that detects temperature of the exhaust gas supplied to the reactor 5, and a controller that controls the heating device 6 based on the temperature measured by the temperature detector.

[Decomposition Method of Chlorine Gas]

The method for decomposing chlorine gas according to the present invention includes bringing a gas containing chlorine gas into contact with the chlorine gas decomposition catalyst according to the present invention in the presence of water.

Bringing the gas containing chlorine gas into contact with the chlorine gas decomposition catalyst according to the present invention in the presence of water (this water is usually water vapor) enables the following reaction to occur and decomposition of chlorine gas.

Cl₂+H₂O→2HCl+1/2O₂

A proportion of chlorine gas in the gas containing chlorine gas is, for example, 0.1 to 10% by volume and preferably 0.1 to 1% by volume at 25° C. and 1 atmosphere pressure.

The gas containing chlorine gas preferably contains water. A proportion of water in the gas containing chlorine gas is, for example, 1 to 40% by volume and preferably 10 to 25% by volume. The volume described here is a value that is converted under standard conditions (0° C., 1.01×10⁵ Pa).

Examples of gases other than chlorine gas and water vapor in the gas containing chlorine gas include, for example, nitrogen gas and argon gas.

The decomposition reaction of chlorine gas is carried out, for example, under the following conditions.

Temperature: 300 to 1,000° C. and preferably 400 to 800° C.

Pressure: Ordinary pressure or pressurized pressure and preferably ordinary pressure.

According to the method for decomposing chlorine gas according to the present invention, it is possible to decompose chlorine gas and particularly chlorine gas contained in exhaust gas, at a high decomposition rate.

### EXAMPLES

Hereinafter, the present invention will be further specifically described based on the Examples, however, the present invention is not limited to the Examples.

(Raw Materials)

The raw materials used in, for examples, the following Examples are as follows:

Cerium(III) nitrate hexahydrate (manufactured by FUJIFILM Wako Pure Chemical Corporation)

Cobalt oxide (Co₃O₄, manufactured by FUJIFILM Wako Pure Chemical Corporation)

Cobalt(II) nitrate hexahydrate (manufactured by FUJIFILM Wako Pure Chemical Corporation)

Nickel(II) nitrate hexahydrate (manufactured by FUJIFILM Wako Pure Chemical Corporation)

Chromium(III) nitrate nonahydrate (manufactured by Strem Chemicals, Inc.)

Iron(III) nitrate nonahydrate (manufactured by FUJIFILM Wako Pure Chemical Corporation)

Manganese(II) nitrate hexahydrate (manufactured by FUJIFILM Wako Pure Chemical Corporation)

Magnesium nitrate hexahydrate (manufactured by FUJIFILM Wako Pure Chemical Corporation)

Zirconium nitrate dihydrate (manufactured by FUJIFILM Wako Pure Chemical Corporation)

Copper(II) nitrate trihydrate (manufactured by FUJIFILM Wako Pure Chemical Corporation)

Yttrium(III) nitrate hexahydrate (manufactured by FUJIFILM Wako Pure Chemical Corporation)

Lanthanum(III) nitrate hexahydrate (manufactured by FUJIFILM Wako Pure Chemical Corporation)

Porous γ-alumina (3 mm diameter, spherical, γ-Al₂O₃)

Porous cordierite (3 mm diameter, spherical, 2MgO·2Al₂O₃·5SiO₂)

Porous silica (3 mm diameter, spherical, SiO₂)

(Catalyst fabrication)

### Example 1

24.4 g of cerium(III) nitrate hexahydrate was dissolved in 53 mL of pure water to obtain an aqueous solution (impregnating solution). By the pore filling method, i.e., to this solution (impregnating solution) was fed 39.0 g of porous γ-alumina as a support, and the porous γ-alumina and cerium nitrate were brought into contact with each other to obtain a support product (1) (in which cerium nitrate was supported on the porous γ-alumina).

The aforementioned support product (1) was air-dried at room temperature for 1 hour, further dried at 60° C. for 24 hours, and then calcined at 500° C. for 2 hours in air to obtain a chlorine gas decomposition catalyst (1).

### Example 2

3.5 g of cobalt oxide was pulverized in a planetary ball mill so that D50 was 1 μm in the particle size distribution, as measured by an average particle size distribution laser diffraction and scattering method, added to 53 mg of pure water, and dispersed by ultrasonic irradiation to obtain a dispersion. This dispersion was used as an impregnating solution.

D50 in particle size distribution was measured as follows.

Cobalt oxide powder in an amount of one cup of an extremely small spatula was added to a small glass bottle, thereto was added 2 mL of 98% ethanol, and the mixture was dispersed by ultrasound for 5 minutes. This solution was charged in a laser diffraction type particle size analyzer manufactured by MicrotracBeL Corp. (Microtrac MT-3000), and measured for the cumulative particle size distribution on a volume basis, confirming that the particle diameter at a cumulative value of 50% (D50) was 1 μm.

Next, according to the pore filling method, i.e., to this impregnating solution was fed 39.0 g of porous γ-alumina that was a support, and the porous γ-alumina and cobalt oxide were brought into contact with each other to obtain a support product (2).

A chlorine gas decomposition catalyst (2) was obtained in the same manner as in Example 1 except that the aforementioned support product (1) was replaced with the aforementioned support product (2).

### Example 3

A chlorine gas decomposition catalyst (3) was obtained in the same manner as in Example 1 except that 24.4 g of cerium(III) nitrate hexahydrate was replaced with 19.2 g of cerium(III) nitrate hexahydrate and 5.8 g of cobalt(II) nitrate hexahydrate.

### Example 4

A chlorine gas decomposition catalyst (4) was obtained in the same manner as in Example 1 except that 24.4 g of cerium(III) nitrate hexahydrate was replaced with 19.2 g of cerium(III) nitrate hexahydrate and 9.7 g of nickel(II) nitrate hexahydrate.

### Example 5

A chlorine gas decomposition catalyst (5) was obtained in the same manner as in Example 1 except that 24.4 g of cerium(III) nitrate hexahydrate was replaced with 24.4 g of cerium(III) nitrate hexahydrate and 13.3 g of chromium(III) nitrate nonahydrate.

### Example 6

A chlorine gas decomposition catalyst (6) was obtained as in Example 1, except that 24.4 g of cerium(III) nitrate hexahydrate was replaced with 19.2 g of cerium(III) nitrate hexahydrate and 14.1 g of iron(III) nitrate nonahydrate.

### Example 7

A chlorine gas decomposition catalyst (7) was obtained as in Example 1, except that 24.4 g of cerium(III) nitrate hexahydrate was replaced with 24.2 g of cerium(III) nitrate hexahydrate and 9.4 g of manganese(II) nitrate hexahydrate.

### Example 8

A chlorine gas decomposition catalyst (8) was obtained as in Example 1, except that 24.4 g of cerium(III) nitrate hexahydrate was replaced with 19.2 g of cerium(III) nitrate hexahydrate and 20.6 g of magnesium nitrate hexahydrate.

### Example 9

A chlorine gas decomposition catalyst (9) was obtained as in Example 1, except that 24.4 g of cerium(III) nitrate hexahydrate was replaced with 24.4 g of cerium(III) nitrate hexahydrate and 7.8 g of zirconium nitrate dihydrate.

### Example 10

A chlorine gas decomposition catalyst (10) was obtained as in Example 1, except that 24.4 g of cerium(III) nitrate hexahydrate was replaced with 19.2 g of cerium(III) nitrate hexahydrate, 5.8 g of cobalt(II) nitrate hexahydrate, and 0.1 g of copper(II) nitrate trihydrate.

### Example 11

13.8 g of cerium(III) nitrate hexahydrate, 3.5 g of cobalt(II) nitrate hexahydrate, and 0.1 g of copper(II) nitrate trihydrate, were dissolved in 53 mL of pure water to obtain a solution (impregnating solution). By the pore filling method, i.e., to this solution (impregnating solution) was fed 39.0 g of porous γ-alumina as a support, and the porous γ-alumina, cerium nitrate, cobalt nitrate, and copper nitrate were brought into contact with each other to obtain a support product (11a). The support product (11a) was air-dried at room temperature for 1 hour, further dried at 60° C. for 24 hours, and then calcined at 500° C. for 2 hours in air to obtain a support product (11b).

Next, 3.5 g of cobalt oxide was pulverized in a planetary ball mill so that an average particle size distribution of the cobalt oxide was 1 μm, as in Example 2, added to 53 mg of pure water, and dispersed by ultrasonic irradiation to obtain a dispersion (impregnation liquid). By the pore filling method, i.e., to this dispersion was fed the support product (11b), and the cobalt oxide was brought into contact with porous γ-alumina to obtain a support product (11).

A chlorine gas decomposition catalyst (11) was obtained in the same manner as in Example 1, except that the support product (1) was changed to the support product (11).

### Example 12

A chlorine gas decomposition catalyst (12) was obtained in the same manner as in Example 3, except that 39.0 g of the porous γ-alumina was replaced with 39.0 g of porous silica.

### Example 13

A chlorine gas decomposition catalyst (13) was obtained in the same manner as in Example 3, except that 39.0 g of the porous γ-alumina was replaced with 39.0 g of porous cordierite.

### Example 14

A chlorine gas decomposition catalyst (14) was obtained in the same manner as in Example 1, except that 24.4 g of cerium(III) nitrate hexahydrate was replaced with 19.2 g of cerium(III) nitrate hexahydrate and 8.4 g of yttrium(III) nitrate hexahydrate.

### Example 15

A chlorine gas decomposition catalyst (15) was obtained as in Example 1, except that 24.4 g of cerium(III) nitrate hexahydrate was replaced with 19.2 g of cerium(III) nitrate hexahydrate and 6.1 g of lanthanum(III) nitrate hexahydrate.

### Example 16

A chlorine gas decomposition catalyst (16) was obtained in the same manner as in Example 1, except for replacement with 13.8 g of cerium(III) nitrate hexahydrate, 3.5 g of cobalt(II) nitrate hexahydrate, and 0.1 g of copper(II) nitrate trihydrate.

### Comparative Example 1

A chlorine gas decomposition catalyst (17) was obtained in the same manner as in Example 1, except that 24.4 g of cerium(III) nitrate hexahydrate was replaced with 16.3 g of nickel(II) nitrate hexahydrate.

### Comparative Example 2

A chlorine gas decomposition catalyst (18) was obtained in the same manner as in Example 1, except that 24.4 g of cerium(III) nitrate hexahydrate was replaced with 22.6 g of iron(III) nitrate nonahydrate.

(Analysis of Catalyst)

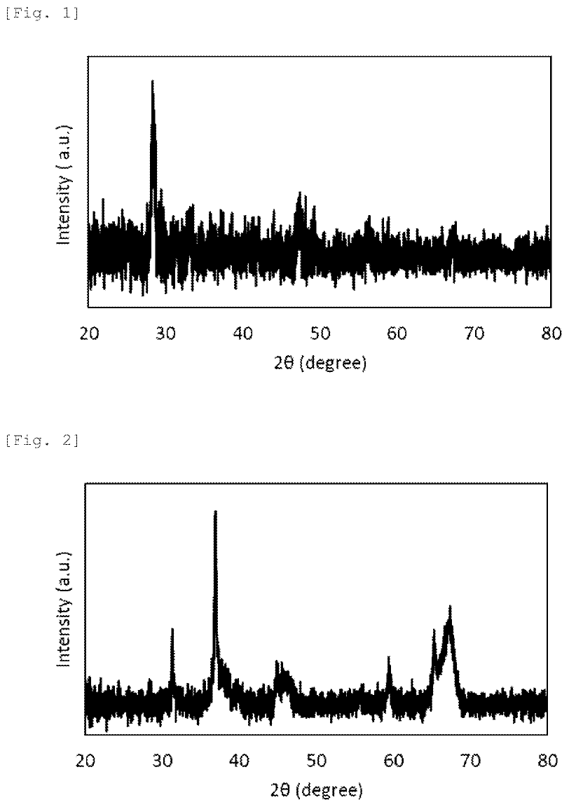

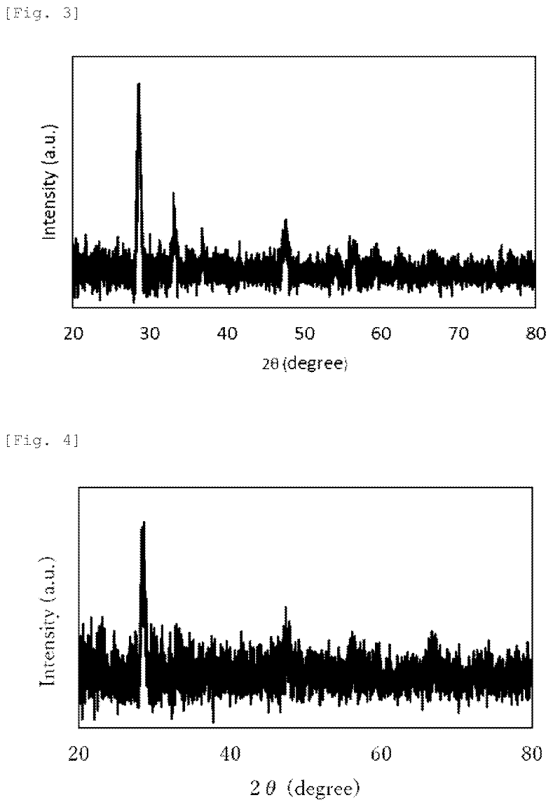

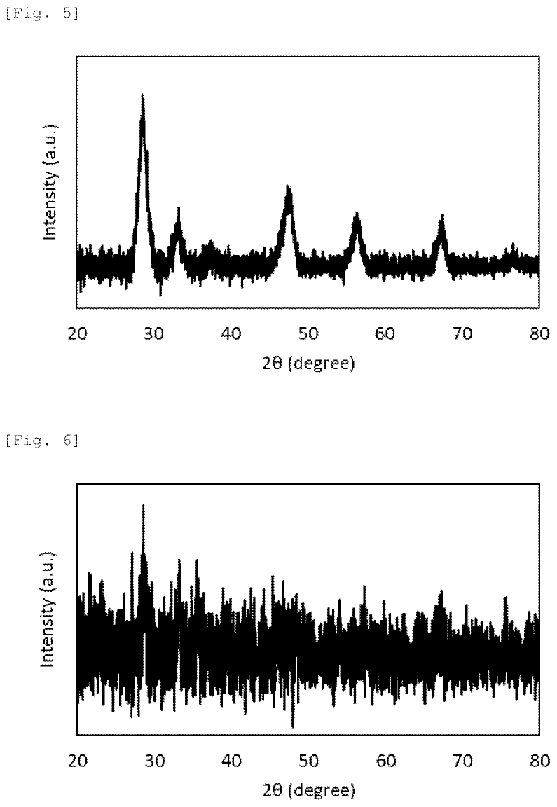

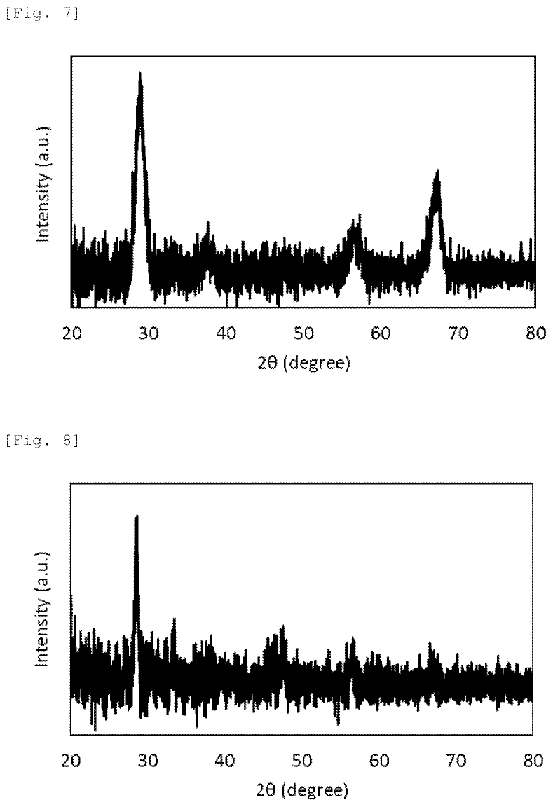

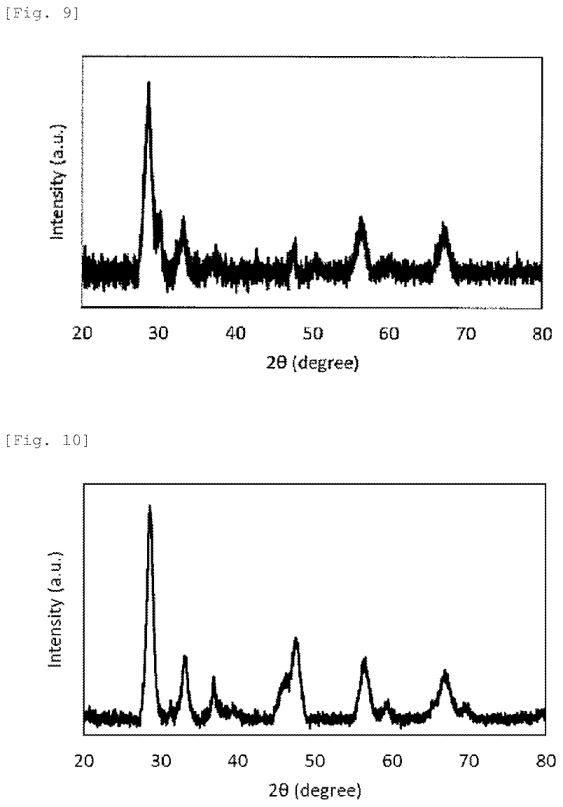

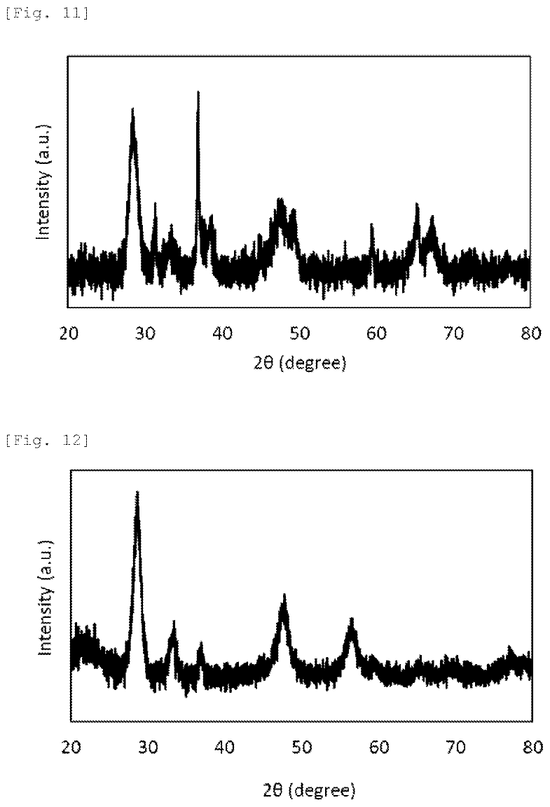

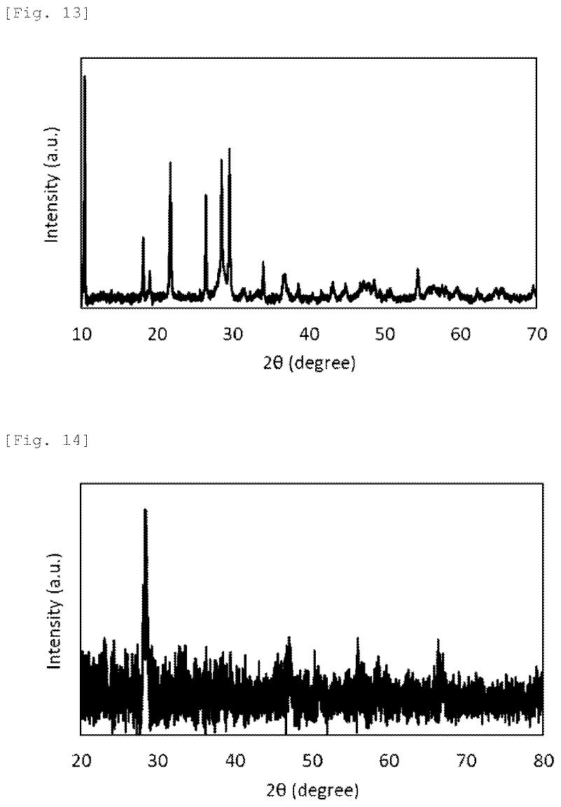

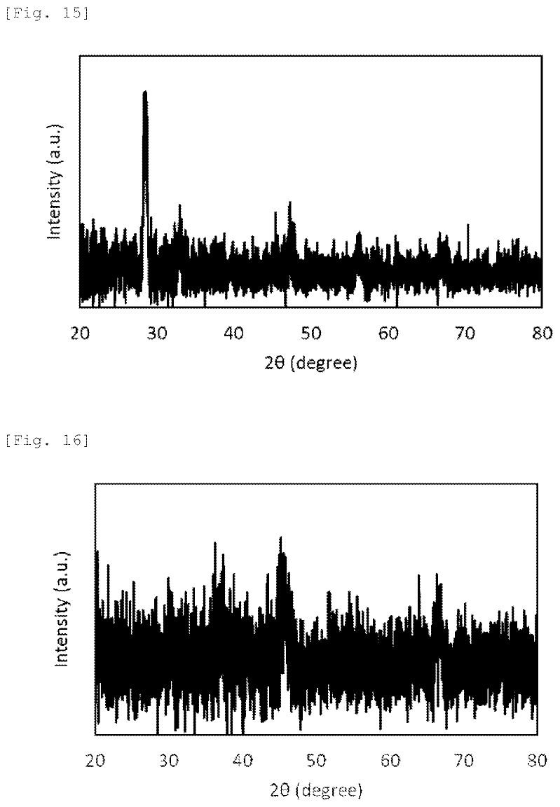

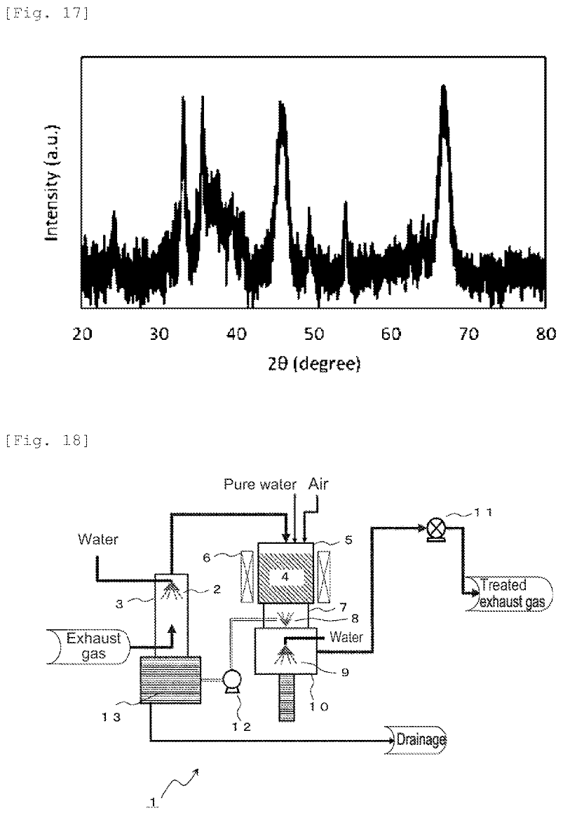

Oxides containing each component or composite oxides containing these components were confirmed by XRD measurement of the chlorine gas decomposition catalysts obtained in the respective Examples and Comparative Examples as shown in FIGS. 1 to 19, and for catalysts that could not be confirmed by XRD measurement, were confirmed by elemental analysis (inductively coupled plasma method (ICP-AES method)).

(Powder X-ray diffraction (XRD) measurement)

The method of XRD measurements is as follows.

The obtained catalyst was pulverized by using an agate mortar for 10 minutes to obtain powder for XRD measurements. By using a powder X-ray diffractometer (PANAlytical MPD manufactured by Spectris pls.), X-ray diffraction measurements of the obtained powder for XRD measurement (Cu-Kα ray (output 45 kV, 40 mA), diffraction angle 28=10 to 80° range, step width: 0.013°, incident side Soller slit: 0.04 rad, incident side Anti-scatter slit: 2°, receiving side Soller slit: 0.04 rad, receiving side Anti-scatter slit: 5 mm) were carried out to obtain X-ray diffraction (XRD) patterns.

(Elemental Analysis (Inductively Coupled Plasma Method (ICP-AES Method)))

Approximately 0.01 g of the catalyst, which was ground in an agate mortar, was weighed into a quartz beaker and dissolved with either HCl, H₂SO₄, or HNO₃ by acid decomposition. After cooling, the volume was fixed at 100 mL, and qualitative analysis by ICP-AES method was performed to convert the amount of the aforementioned metal element M contained in an amount of 0.05% by weight or more in the catalyst to a proportion relative to 1 mole of Ce atoms. The analysis was performed with n=1. (Apparatus: Agilent 5110 (Agilent technology))

(Chlorine Gas Decomposition Measurement)

A reaction tube made of Inconel (70 cc in volume) was filled with the chlorine gas decomposition catalyst obtained in each of Examples and Comparative Examples. Upon the reaction, the volume of each gas was adjusted so that a mixed gas had a volume ratio of chlorine gas: nitrogen gas: water vapor in the reaction tube of 0.5:74.5:25 (in terms of volumes at 0° C. and 1.01×10⁵ Pa), and the mixed gas was supplied into the reaction tube at 5,000 cc/min (in terms of volume at 0° C. and 1.01×10⁵ Pa) under ordinary pressure. Specifically, chlorine gas and nitrogen gas were mixed by adjusting their volume ratio using a mass flow controller, and the gas with this flow rate being adjusted was introduced into the reaction tube. Pure water at ordinary temperature was introduced by a pump into a preheating section (400° C.) from an inlet different from an inlet for mixed gas, while measuring its weight so as to achieve the above volume ratio, then vaporized and introduced into the reaction tube to be merged with the aforementioned mixed gas of chlorine gas and nitrogen gas. The reaction tube was heated to 500° C. in an electric furnace, and at the time of 1 hour after the start of the reaction, the gas at an outlet of the reaction tube was sampled by distributing it through a potassium iodide aqueous solution, and the amount of chlorine gas was quantified by an iodine titration method, and a decomposition rate of chlorine gas was measured as defined in the formula below.

Decomposition rate (%)={(0.5−proportion of chlorine gas in outlet gas (% by volume))/0.5)×100 wherein the proportion of chlorine gas in the outlet gas was converted to a proportion under standard conditions (0° C. and 1.01×10⁵ Pa).

The composition of the gas exhausted from the outlet of the reaction tube was confirmed to be almost constant by having distributed the gas with the flow rate being adjusted, for 1 hour until the start of the reaction. The same applies for the case upon mixing the PFC described below.

The results are shown in Table 1.

(Chlorine Gas Decomposition Measurement Upon Mixing PFC)

In order to measure a chlorine gas decomposition rate upon mixing PFC, a reaction tube made of Inconel (70 cc in volume) was filled with the chlorine gas decomposition catalyst obtained in Example 16. Upon the reaction, the volume of each gas was adjusted so that a mixed gas had a volume ratio of C₄F₈ gas: chlorine gas: nitrogen gas: water vapor in the reaction tube was 0.5:0.5:84:15 (in terms of volumes at 0° C. and 1.01×10⁵ Pa), and the mixed gas was supplied into the reaction tube at 5,000 cc/min (in terms of volume at 0° C. and 1.01×10⁵ Pa) under ordinary pressure. Specifically, the C₄F₈ gas, chlorine gas and nitrogen gas were mixed by adjusting their volume ratio using a mass flow controller, and the gas with a flow rate being adjusted was introduced into the reaction tube. Pure water at ordinary temperature was introduced by a pump into a preheating section (400° C.) from an inlet different from an inlet for mixed gas, while measuring its weight so as to achieve the above volume ratio, then vaporized and introduced into the reaction tube to be merged with the aforementioned mixed gas of C₄Fₑ gas, chlorine gas and nitrogen gas. The reaction tube was heated to 750° C. in an electric furnace so that a high decomposition rate of C₄F_{A} gas that was a PFC gas could be obtained, and at the time of 1 hour after the start of the reaction, the gas at an outlet of the reaction tube was sampled by distributing it through a potassium iodide aqueous solution, and the amount of chlorine gas was quantified by the iodine titration method, and a decomposition rate of chlorine gas was measured as defined in the formula below.

Decomposition rate (%)={(0.5−proportion of chlorine gas in outlet gas (% by volume))/0.5}×100 wherein the proportion of chlorine gas in the outlet gas was converted to a proportion under standard conditions (0° C. and 1.01×10⁵ Pa).

The results are shown in Table 2.

TABLE 1

| | | Catalyst composition | | | | | | |
|---|---|---|---|---|---|---|---|---|
| | | | Metallic | Metallic | | | | |
| | | | element | element | | Chlorine gas | | |
| | | | 1/Ce | 2/Ce | | decomposition conditions | | Decomposition |
| | | | (molar | (molar | Support | Chlorine gas | Decomposition | rate of |
| | Catalyst | Oxide | ratio) | ratio) | material | concentration | temperature | chlorine gas |
| Example 1 | (1) | Ce oxide | — | — | γ-alumina | 0.5% by | 500° C. | 95.1% |
| | | (CeO₂) | | | | volume | | |
| Example 2 | (2) | Co oxide | — | — | | | | 98.7% |
| | | (Co₃O₄) | | | | | | |
| Example 3 | (3) | Ce-Co | 0.45 | — | | | | 93.1% |
| | | oxide | | | | | | |
| Example 4 | (4) | Ce—Ni | 0.75 | — | | | | 92.9% |
| | | oxide | | | | | | |
| Example 5 | (5) | Ce—Cr | 0.59 | — | | | | 97.4% |
| | | oxide | | | | | | |
| Example 6 | (6) | Ce—Fe | 0.79 | — | | | | 91.9% |
| | | oxide | | | | | | |
| Example 7 | (7) | Ce—Mn | 0.58 | — | | | | 92.3% |
| | | oxide | | | | | | |
| Example 8 | (8) | Ce—Mg | 1.8 | — | | | | 84.5% |
| | | oxide | | | | | | |
| Example 9 | (9) | Ce—Zr | 0.52 | — | | | | 84.1% |
| | | oxide | | | | | | |
| Example 10 | (10) | Ce—Co—Cu | 0.45 | 0.009 | | | | 95.6% |
| | | oxide | (Co) | (Cu) | | | | |
| Example 11 | (11) | Co₃O₄ + | 1.8 | 0.013 | | | | 98.7% |
| | | Ce—Co—Cu | (Co) | (Cu) | | | | |
| | | oxide | | | | | | |
| Example 12 | 12) | Ce—Co | 0.45 | — | Silica | | | 97.3% |
| | | oxide | | | | | | |
| Example 13 | (13) | Ce—Co | 0.45 | — | Cordierite | | | 98.4% |
| | | oxide | | | | | | |
| Example 14 | (14) | Ce—Y | 0.50 | — | γ-alumina | | | 76.1% |
| | | oxide | | | | | | |
| Example 15 | (15) | Ce—La | 0.32 | — | | | | 71.6% |
| | | oxide | | | | | | |
| Comparative | (17) | Ni oxide | — | — | | | | 56.5% |
| Example 1 | | (NiO) | | | | | | |
| Comparative | (18) | Fe oxide | — | — | | | | 54.3% |
| Example 2 | | (Fe₂O₃) | | | | | | |

As shown in Table 1, the decomposition rate of chlorine gas was confirmed to be 70% or more for the catalysts of composite oxides containing the Ce oxide, Co oxide, and Ce.

TABLE 2

| | | Catalyst composition | | | | | | Decomposition |
|---|---|---|---|---|---|---|---|---|
| | | | Metallic | Metallic | | | | rate of chlorine |
| | | | element | element | | Chlorine gas | | gas in mixed |
| | | | 1/Ce | 2/Ce | | decomposition conditions | | gas of PFC |
| | | | (molar | (molar | Support | Chlorine gas | Decomposition | gas and |
| | Catalyst | Oxide | ratio) | ratio) | material | concentration | temperature | chlorine gas |
| Example 16 | (16) | Ce—Co—Cu | 1.8 | 0.013 | γ-alumina | 0.5% by | 750° C. | 99.54% |
| | | Oxide | (Co) | (Cu) | | volume | | |

### REFERENCE SIGNS LIST

1. Exhaust gas treatment apparatus
2. Spray
3. First scrubber
4. Chlorine gas decomposition catalyst
5. Reactor
6. Heating device
7. Cooler
8. Cooling device (spray)
9. Spray
10. Second scrubber
11. Blower
12. Pump
13. Tank

1. A chlorine gas decomposition catalyst comprising a metal oxide (X), wherein
the metal oxide (X) comprises an oxide (X1) of at least one element selected from the group consisting of Ce and Co.

2. The chlorine gas decomposition catalyst according to claim 1, wherein the oxide (X1) comprises cerium oxide.

3. The chlorine gas decomposition catalyst according to claim 1, wherein the oxide (X1) comprises a composite oxide of Ce and at least one element M selected from the group consisting of Mg, Cr, Mn, Fe, Co, Ni, Cu and Zr.

4. The chlorine gas decomposition catalyst according to claim 3, wherein the metal oxide (X) further comprises an oxide of the element M excluding Co.

5. The chlorine gas decomposition catalyst according to claim 1, wherein the oxide (X1) comprises cobalt oxide.

6. The chlorine gas decomposition catalyst according to claim 1, comprising a support and the metal oxide (X) supported on the support.

7. The chlorine gas decomposition catalyst according to claim 1 for decomposing chlorine gas contained in exhaust gas.

8. An exhaust gas treatment apparatus comprising a reactor into which exhaust gas containing chlorine gas is introduced, wherein the reactor is provided with the chlorine gas decomposition catalyst according to claim 1.

9. The exhaust gas treatment apparatus according to claim 8, wherein the exhaust gas contains a perfluoro compound.

10. The exhaust gas treatment apparatus according to claim 9, wherein the reactor is provided with a perfluoro compound decomposition catalyst.

11. The exhaust gas treatment apparatus according to claim 8, comprising a device that supplies water to the exhaust gas.

12. The exhaust gas treatment apparatus according to claim 8, comprising a heating device that heats the exhaust gas.

13. The exhaust gas treatment apparatus according to claim 8, comprising a cooling device that cools gas exhausted from the reactor.

14. The exhaust gas treatment apparatus according to claim 8, comprising a removal device that removes an acid gas from gas exhausted from the reactor.

15. The exhaust gas treatment apparatus according to claim 8 comprising a temperature detector that detects a temperature of the exhaust gas supplied to the reactor, and a controller that controls the heating device based on temperature measured by the temperature detector.

16. A method for decomposing chlorine gas, comprising bringing a gas containing chlorine gas into contact with the chlorine gas decomposition catalyst according to claim 1 in the presence of water.
